(19) United States
(12) Patent Application Publication
(10) Pub. No.: US 2003/0118498 A1
(43) Pub. Date: Jun. 26, 2003

(54) Method for recuperating thermal energy of gases of an electrometallurgical furnace and use for making silica powder

(76) Inventor: Jean-Andre Alary, Isle sur la Sorgue (FR)

Correspondence Address: Connolly Bove, Lodge & Hutz, Suite 800, 1990 M Street NW, Washington, DC, 20036-3425, US

(21) Appl. No.: 10/221,264

(22) PCT Filed: Mar. 26, 2001
(86) PCT No.: PCT/FR01/00912

(30) Foreign Application Priority Data
Mar. 28, 2000 (FR) 00/03902

(51) Int. Cl. C01B 33/12

(52) U.S. Cl. 423/335

(57) ABSTRACT

The invention concerns a method for recuperating thermal energy of hot gases of a submerged-arc furnace designed to make metal alloys by atomization of a powder from solid particles suspended in an aqueous phase. The solid particles are, preferably, derived from the filtering of gases emitted by the electric furnace. The invention also concerns a method for making silica powder with improved properties from fumes of a silicon or ferro-silicon furnace, which consists in preparing a suspension of said fumes in water and atomizing said suspension.

### FIELD OF THE INVENTION

The invention relates to a process for recovering the heat energy contained in gases produced by an electrometallurgical furnace, particularly a submerged electric arc furnace producing metal alloys from oxides. It also relates to the application of this process to the preparation of a silica powder, with good flow and dispersion properties, from the silica fumes recovered in the gases of furnaces manufacturing metallurgical grade silicon and ferro-silicon.

### PRIOR ART

A number of processes for manufacturing metals and alloys electrothermally consist in reducing with carbon, in a submerged electric arc furnace, one or more oxidised compounds, particularly silica, giving significant production of gas, for example carbon monoxide, which burns in the upper part of the load. This is the case for example with metallurgical grade silicon, silicon, chrome or manganese based alloys, and with calcium carbide. Discharging these gases into the atmosphere at a high temperature leads to significant energy losses.

Attempts have therefore been made to recover this wasted energy. The paper by H. Bromet of the Compagnie Universelle d'Acétylène et d'Electrométallurgie, given at INFACON 80 (Second International Congress on ferro-alloys, Lausanne, Oct. 13-16, 1980), published in the Proceedings in 1981, pp 17-34, shows an example of energy recovery for a 50 MW furnace at the Dunkirk factory, which at the time was producing ferro-silicon 75. The energy was recovered in vapour form, and then converted into electrical energy using a turbo-generator. The patent FR 2517422, filed in 1981 in the name of SociétéFrançaise d'Electrométallurgie, describes a device for collecting the gases in the furnace which allows such recovery. Recovering the energy of hot gases in vapour form and using them for activities set up near the furnace, or to produce a proportion of the electrical energy (about 15 to 20%) consumed by the furnace, is practised today, notably in the Scandinavian countries. Such installations represent significant investment, the return on which depends on the local economic context.

Furthermore, manufacturing metallurgical grade silicon, or silicon alloys such as-ferro-silicon, in an electric arc furnace is accompanied by a significant release of gas with silica fumes made up of fine particles, smaller than 500 μm, with a sizeable fraction below 40 μm. These fumes are recovered essentially in gas filtering plants, in the form of a powder with a density of between 0.15 and 0.20. Their principal application has been in the reinforcement of concrete, but other applications would be conceivable if it was known how to produce much finer powders.

For reasons of cost, the powder must be densified before being shipped to users. Various densification processes are used, for example those described in the patents FR 2349539, FR 2349540 and FR 2363369. The powders then reach a density of between 0.5 and 0.8 but they often have insufficient flowability, which may lead to jamming when transferring the product from a storage installation to a point of use.

To avoid these drawbacks, some producers market silica powders in slurry form, composed of a dispersion of silica particles in water at a high concentration, possibly up to 1 kg of silica particles for 1 kg of water. The suspension is stabilised by adding sulphuric acid until a slightly acid medium is obtained (pH between 5 and 7), which is sufficient to save any decantation for several weeks, or even several months. This means that a very fine silica can be supplied to the user, but with the drawback of having to ship as much water as silica.

### OBJECT OF THE INVENTION

The purpose of the invention is to recover the heat energy of the hot gases in an electrometallurgical furnace in a cost-effective way without the need for costly investment. Another purpose, in the case of silicon or ferro-silicon furnaces, is to use the recovered heat energy to produce silica powders with improved use properties.

The object of the invention is a process for recovery the heat energy of the hot gases of a submerged electric arc furnace intended to manufacture metal alloys for the atomisation of a powder from a suspension of solid particles in an aqueous phase. The solid particles come, preferably, from the filtration of the gases produced by the electric furnace.

Another object of the invention is a process for manufacturing silica powder with improved properties from the fumes of a silicon or ferro-silicon furnace, comprising the preparation of a suspension of these fumes in water and the atomisation of this suspension, preferably using the heat energy of the hot gases of the furnace.

### DESCRIPTION OF THE INVENTION

The invention is based on the idea of recovering the heat energy contained in the hot gases produced by electrometallurgical furnaces, not in vapour form or in the form of electrical energy as in the prior art, but directly in an application requiring a hot gas. This is the case of the atomisation of a powder from a suspension of solid particles in water, for which a great deal of energy is required in order to evaporate the water. This application is particularly advantageous when the solid particles come from the metallurgical reduction itself, like the fumes present in the hot gases produced by the furnace.

All operations for reducing metal oxides with carbon in a submerged electric arc furnace produce a release of hot gases, containing a more or less significant quantity of particles of fumes consisting of oxides. It is at all events necessary to prevent these fumes being discharged into the environment and it may be economically advantageous to make a useful and saleable product from these recovered fumes. This has been the case, for a number of years, with the silica fumes arising from the manufacture of metallurgical grade silicon and ferro-silicon in an electric arc furnace.

In this case, which will be chosen in order to describe a particular implementation of the invention, the gases produced in the furnace are collected by suction at the apex of the furnace and the dust removed, for example using bag filters. Depending on the nature of the materials used for the filters, the temperature of the gases may be lowered before filtration by adding additional air. With glass fibre filter bags, clean gases are recovered at a temperature of between 200° C. and 230° C., and the solid silica particles are collected in the form of raw powder. The gases with dust removed may contain very fine residual particles, which have escaped the filtration, in a quantity of less than 50 mg/Nm³, but they are sufficiently clean to be used in the invention process.

The raw silica powder recovered at filtration is mixed with water, in a quantity between 0.5 and 1 kg for 1 l of water, by mixing in a mixer. In accordance with the known prior art for the preparation of suspensions of silica fumes, sulphuric acid is added, so as to obtain a slightly acid pH, between 5 and 7, and preferably around 5.5. The suspension obtained is filtered to 2 mm to eliminate the foreign bodies present in the coarse fumes, then hydrocycloned to perfect this separation. Thus a suspension is obtained which is practically free of particles of a size larger than 10 μm.

This treatment may be completed by adding a non-miscible liquid, for example an oil, which will selectively collect the carbonaceous product particles, which are the largest and the most highly coloured particles. By decantation, separation is obtained of an organic phase, which is eliminated, and a suspension which is practically free of particles larger than 1 μm, and of grey or black coloured particles, which makes it possible at the end of the process to obtain a silica which is both finer and whiter, as required in respect of some applications. If it is desired to obtain a silica with a low alkaline cell content, it is possible, before adding sulphuric acid, to separate the silica and its washings by decantation, then to prepare a new suspension with a further addition of water.

The suspension is then presented in a quasi-homogenous form, and does not decant when it is at rest. This behaviour is quite surprising, insofar as a simple mixture of water and silica fumes leads to a suspension which deposits sediment in a few minutes. To reconcile the observed phenomenon and Stokes Law the applicant has put forward the hypothesis that the addition of sulphuric acid leading to the suspension causes an unexpected dispersion of silica particles, and evaporating it could lead to a fine powder, which has been confirmed by the experiment.

The suspension obtained is then pressurised between 0.2 and 0.5 mPa, then sprayed in mist form, through a jet, into an atomisation chamber swept by the gases with dust removed entering the atomisation chamber at a temperature of about 200 to 230° C. The energy required to evaporate the water from the suspension may thus be provided entirely by the enthalpy of the gases. A conventional atomisation installation may be used, for example a NIRO® atomiser like those used in the ceramics industry and in the food-processing industry.

Instead of sending the hot gases with dust removed into the atomisation chamber directly, it is possible to send into it clean air, which has been heated by the furnace gases, through a gas-gas heat exchanger, these furnace gases having either had the dust removed or not removed.

The atomised silica provided by the invention process has physical properties far superior to those of the silica fumes of the prior art, particularly excellent flowability and very good redispersability in concrete.

Flowability, expressed as flow time, is measured by means of an assembly simulating the draining of a silo by suction. In a glass column 100 mm in diameter and 600 mm high, open to the open air, is placed 2 kg of the silica powder whose flowability is to be measured. The bottom of the column terminates in a 45° cone connected to a tube of 24 mm diameter, by which a 2200 mm water column depression is created in other words 215 hPa. The time necessary for all the dust contained in the column to flow is then measured, this result being used to express the flowability.

Whereas for the densified silica powders of the prior art flow times of 20 to 45 seconds are measured, for the atomised silica powder of the present invention values of 4 to 10 seconds are found.

The particle size parameters of silicon powders may be measured using a laser particle size analyser CILAS LS 230, for powders dispersed in water without applying ultrasound. For a raw electric furnace silica powder arising from silicon manufacture, and then aerocycloned in order to eliminate from it about 5% corresponding to the coarsest fractions, a median particle size of 20 μm is measured, the coarsest particles of this powder rising to 200 μm.

For the same powder with the density taken to 0.57 by mechanical means, a median particle size of 40 μm is measured, the coarsest particles of this powder rising to 400 μm. For powder of the same origin processed according to the invention process, a particle size of less than 1 μm is measured for almost all the particles.

Very similar results are obtained for a coarse electric furnace silica powder arising from ferro-silicon 75 manufacture.

Hunter method chromaticities were adopted, using the chromatic parameters L, a and b, where perfect white is expressed by L=100, and black by L=0. In this colorimetric system, the reference powder for white is anhydrous barium sulphate. The atomised silica of the invention gives values of L between 60 and 70, and between 70 and 80 if the suspension has been subject to an extraction of carbonaceous residues by an organic liquid which is non-miscible in water, as against 45 to 55 in respect of the prior art silica. The atomised silica which is the subject of the invention gives values of between 0.3 and 0.4 as against 0.5 to 0.8 or 0.15 to 0.2 in respect of the prior art silica powder according to whether the silica powder is or is not densified.

When determined by conventional chemical analysis, the SiO₂ content of the atomised silica produced according to the invention from fumes produced by a furnace manufacturing metallurgical grade silicon has values of between 0.90 and 0.98 as against 0.85 to 0.95 in respect of prior art silica powder.

### EXAMPLES

### Exemple 1

A 10 kg sample of fumes is taken from a dust removal installation processing the gases of a 20 MW furnace making metallurgical grade silicon. This sample is divided into two identical parts. One of the parts of this sample is densified in a laboratory according to the process described in the patent FR 2.349.539. Flowability on 35s is measured for the product obtained.

A concrete specimen is prepared according to the following composition:

Silica sand in 0.2/1 mm :1,000 cm³

Cement: 300 g

Water: 180 cm³

The specimen is then split and polished for micrographic examination. The coarsest particles of amorphous silica observed and arising from the silica smoke measure 240 μm.

### Example 2

The non-densified sample part of the previous example is dispersed in 5 litres of water and the pH is brought progressively to 5.5 by adding sulphuric acid. The suspension obtained is passed through a stainless steel gauze with a 2 mm mesh, then decanted for 30 minutes in order to eliminate some coarse particles with a total mass of 42 g.

This suspension is then atomised at 0.3 MPa on a laboratory installation supplied with air heated to 230° C. 4.7 kg of atomised powder is recovered for which a flowability of 3s is measured. With this atomised powder a concrete specimen is remade in the conditions of example 1.

The micrographic examination of this specimen reveals no amorphous silica particle of a size greater than 8 μm.

### Example 3

### Process Heat Balance

The purpose of the example below is to evaluate the energy portion which can be recovered according to the process. A furnace operating at 10 MW, producing silicon, consumes about 11,000 to 12,500 kWh per ton of silicon produced. The production of fumes is between 250 and 600 kg/t of silicon. If we take median values of 11,750 kWh and 450 kg of fumes per tonne of Si, the following results are obtained:

To produce 0.85 t/h of silicon, 383 kg/h of fumes are produced which are for example put into suspension in a proportion of ⅓ of silica dust and ⅔ of water. Manufacturing atomised silica will require the evaporation of 766 kg of water per hour, which requires a thermal output of 550 kW.

Since the thermal output lost by the gases coming from the furnace is about 0.6 to 1 times the electric power of the furnace, this value varying with the type of reducers used, the power used in manufacturing atomised silica according to the invention process therefore allows about 8% of the lost energy to be recovered.

1. A process for manufacturing a fine silica powder comprising the recovery of silica fumes produced during the manufacture of metallurgical grade silicon or silicon alloys in a submerged electric arc furnace, the preparation of a suspension of this silica in water, and the atomisation of this suspension.

2. A process according to claim 1, characterised in that, for the atomisation, the heat energy of the hot gases produced by the furnace is used.

3. A process according to claim 2, characterised in that, for the atomisation, the hot gases produced by the furnace are used directly, having been previously cleared of the majority of solid particles.

4. A process according to claim 2, characterised in that, for the atomisation, air reheated by heat exchange by the gases produced by the furnace is used.

5. A process according to one of the claims 1 to 4, characterised in that, before atomisation, the suspension is treated by a non-miscible liquid in order to eliminate the impurities and the coarsest particles from it.

6. Atomised silica arising from the process according to one of the claims 1 to 5, characterised in that the size of the particles is less than 10 μm.

7. Atomised silica arising from the process according to claim 5, characterised in that the size of the particles in the redispersed state in water is less than 1 μm.

8. Atomised silica arising from the process according to one of the claims 1 to 5, characterised in that its whiteness index L in the Hunter system is between 60 and 70.

9. Atomised silica arising from the process according to claim 5, characterised in that its whiteness index L in the Hunter system is between 70 and 80.

8. A process according to claim 7, characterised in that, for atomisation, the hot gases produced by the furnace are used directly, having been previously cleared of the majority of solid particles.

9. A process according to claim 7, characterised in that, for atomisation, air reheated by heat exchange by the gases produced by the furnace is used.

10. A process according to one of the claims 6 to 8, characterised in that, before atomisation, the suspension is treated by a non-miscible liquid in order to eliminate the impurities and the coarsest particles from it.

11. Atomised silica arising from the process according to one of the claims 6 to 9, characterised in that the size of the particles is less than 10 μm.

12. Atomised silica arising from the process according to claim 10, characterised in that the size of the particles in the redispersed state in water is less than 1 μm.

13. Atomised silica arising from the process according to one of the claims 6 to 9, characterised in its whiteness index L in the Hunter system is between 60 and 70.

14. Atomised silica arising from the process according to claim 10, characterised in that its whiteness index L in the Hunter system is between 70 and 80.
